(19) United States
(12) Patent Application Publication
(10) Pub. No.: US 2011/0008495 A1
(43) Pub. Date: Jan. 13, 2011

(54) LIQUID DIETARY SUPPLEMENT COMPOSITION

(75) Inventor: Robert Paul, Chesterfield, MO (US)

Correspondence Address: SENNIGER POWERS LLP, 100 NORTH BROADWAY, 17TH FLOOR, ST LOUIS, MO, 63102, US

(73) Assignee: NAWGAN PRODUCTS, LLC, Chesterfield, MO (US)

(21) Appl. No.: 12/831,846

(22) Filed: Jul. 7, 2010

Related U.S. Application Data
(60) Provisional application No. 61/313,041, filed on Mar. 11, 2010.
(60) Provisional application No. 61/224,312, filed on Jul. 9, 2009.

(51) Int. Cl. A23L 1/30; A23L 1/302

(52) U.S. Cl. 426/72; 426/541

(57) ABSTRACT

The present invention is directed to liquid dietary supplement compositions comprising lycopene. These compositions are useful in enhancing cognitive ability.

### CROSS-REFERENCE TO RELATED APPLICATIONS

This application claims the benefit of U.S. Provisional Application No. 61/313,041, filed Mar. 11, 2010, and U.S. Provisional Application No. 61/224,312, filed Jul. 9, 2009, the entireties of which are herein incorporated by reference.

### FIELD OF THE INVENTION

The present invention is directed to liquid dietary supplement compositions comprising lycopene. These compositions are useful in enhancing cognitive ability.

### BACKGROUND OF THE INVENTION

Various liquid dietary supplements have been marketed recently as providing physical and mental health benefits, especially cognitive benefits. However, such liquid dietary supplements suffer several drawbacks. For example, no liquid dietary supplement has been developed that has been formulated to address multiple critical mechanisms of declining cognitive health secondary to advanced age in adults. In addition, the liquid dietary supplements that have been developed typically utilize ingredients that have not been demonstrated to support cognitive health in the context of aging. Such liquid dietary supplements often have other drawbacks, such as high calorie content, poor flavor, and ingredients many people find undesirable, like preservatives and artificial additives. Moreover, even such liquid dietary supplements that do contain an ingredient or two that has been associated with supporting cognitive abilities typically contain only one or two such ingredients, which are associated with only one or two facets of cognitive abilities or mechanism related thereto.

Many chemicals have been studied regarding their effect on cognitive function. Acetylcholine is recognized as an important chemical in the body and the brain, and is understood to be necessary in the brain for normal cognitive function, particularly memory function. Early theories regarding the cause of Alzheimer's disease were based on abnormalities in the acetylcholine system (i.e., cholinergic hypothesis) and today nearly all currently available medications for the treatment of Alzheimer's disease work to maximize the acetylcholine system in the brain. Irizarry M C, Hyman B T. Alzheimer disease therapeutics. J Neuropathol Exp Neurol. 2001 October; 60(10):923-8. Pharmaceutical and experimental manipulations of the acetylcholine system in humans and animals are among the most reliable paradigms in the field of behavioral neuroscience. Overall these studies reveal that when acetylcholine levels are low, memory and other thinking skills become impaired.

Both synthesis and stimulation-induced release of acetylcholine have been found to decline with age in healthy individuals. Decker M W. The effects of aging on hippocampal and cortical projections of the forebrain cholinergic system. Brain Res. 1987; 434(4):423-38. In addition, the number of receptors available for binding to the (lower) levels of acetylcholine has been found to be significantly reduced in older individuals, indicating that significant amounts of a key chemical necessary for memory and that the receptors responsible for relaying the effects of the key chemical are lost with age. An identical process also has been noted in the context of Alzheimer's disease.

In Europe, A-GPC has been relied on for many years as a primary treatment for Alzheimer's disease and stroke with consistent and highly effective results. For example, Parnetti and colleagues studied 126 individuals diagnosed with mild to moderate Alzheimer's disease. Individuals were administered A-GPC over a 6 month period of time and their performances were compared to patients who had not been given A-GPC over the same period. Parnett L., Abate, G., Bartorelli, L., Cucinotta, D., Cuzzupoli, M., Maggioni, M., Villardita, C., Senin, U. (1993). Multicentre study of I-alpha glyceryl phosphorylcholine vs. ST200 among patients with probable Senile Dementia of Alzheimer's Type. Drugs and Aging, 3, 159-164. Results of the study revealed significant improvements in verbal memory and overall cognitive ability among individuals taking A-GPC. In fact, the absolute magnitude of change in overall cognitive ability (as measured by the Mini Mental State Exam) offset a full year of typical decline in cognitive ability associated with Alzheimer's disease.

Lycopene is a compound in the carotenoid family. Carotenoids provide the color in fruits and vegetables (e.g., lycopene provides the red color in tomatoes and watermelon). Lycopene has long been recognized as a health promoter, with studies reporting benefits to cardiovascular health, prostate health, and cancer cell disruption. More directly related to the brain, lycopene is present in normal brain tissue where it is believed to reduce oxidative stress and reduce inflammation. Oxidative stress occurs when antioxidant mechanisms and pro-oxidant forces are unbalanced. As with most forms of “stress,” oxidative stress is considered undesirable. Both oxidative stress and inflammation disrupt brain function and they are believed to play a prominent role in “age-related” cognitive decline and many forms of brain dysfunction.

Low levels of lycopene have been associated with poorer thinking skills. In particular, Akbaraly et al. examined 589 older adults and reported that individuals with the lowest levels of lycopene performed most poorly on tests of processing speed and cognitive flexibility; two cognitive domains predominately affected by advanced age. Akbaraly N T, Faure H, Gourlet V, Favier A, Berr C. Plasma carotenoid levels and cognitive performance in an elderly population: results of the EVA Study. J Gerontol A Biol Sci Med Sci. 2007; 62(3):308-16. Another critical study by Kuhad et al. demonstrated that long-term consumption of lycopene in distilled water significantly improved memory performance in diabetic animals, and markers of inflammation and oxidation significantly decreased. Kuhad A, Sethi R, Chopra K. Lycopene attenuates diabetes-associated cognitive decline in rats. Life Sci. 2008; 18; 83(3-4):128-34. While these are only representative studies, they highlight the relevance lycopene is understood to have as a natural agent to reduce inflammation and oxidative stress in the brain and in turn improve memory and cognitive abilities.

Natural tocopherols are present in the brain and absolute concentrations in the brain have been found to decline with age. Craft N E, Haitema T B, Garnett K M, Fitch K A, Dorey C K. Carotenoid, tocopherol, and retinol concentrations in elderly human brain. J Nutr Health Aging. 2004; 8(3):156-62. Preliminary studies also reveal that supplementation of Vitamin E may slow cognitive decline. Grodstein F, Chen J, Willett W C. High-dose antioxidant supplements and cognitive function in community-dwelling elderly women. Am J Clin Nutr. 2003; 77(4):975-84.

Further, numerous studies have demonstrated that natural Vitamin E is a very powerful antioxidant in the brain and low levels of Vitamin E in the plasma are associated with poorer cognitive function. Experts seem to agree that both synthetic and natural forms of most vitamins are generally equal in terms of their physical structures and biological activities in the human body with the exception of Vitamin E. Natural Vitamin E is obtained from vegetable oils (e.g., soybean, cornflower, etc). Natural Vitamin E is a single chemical entity (referred to as a stereoisomer). By contrast, synthetic Vitamin E is created by combining trimethylhydroquinone with isophytol and the result is a combination of 8 different chemical structures but only one of them is similar to natural vitamin E. Overall, synthetic Vitamin E shares about 12% similarity to natural Vitamin E in terms of physical structure and the lack of similarities results in profound differences in absorption and biological activities. In fact, in terms of bioavailability, natural Vitamin E is more available to body cells than synthetic Vitamin E. Further, synthetic Vitamin E is preferentially metabolized and excreted in the urine rather than absorbed and used by the body.

More than 500 research articles have been published in peer-reviewed journals that have focused on the pharmacological actions and benefits of citicoline. The compound is well-regarded in the basic science and clinical literature with a particular interest in the area of stroke management. The compound has been available commercially for many years but it had not received GRAS approval until May 2009. A recent study conducted by Harvard Medical School revealed that citicoline (Cognizin®) produces significant alterations in brain function among healthy adults. Silveri M M, Dikan J, Ross A J, Jensen J E, Kamiya T, Kawada Y, Renshaw P F, Yurgelun-Todd D A. NMR Biomed. 2008 November; 21(10):1066-75. Numerous other studies have reported that citicoline benefits cognitive function in three separate pathways. First, citicoline increases acetylcholine levels (similar to A-GPC). Second, citicoline provides phospholipid support to brain cells (critical for healthy maintenance of neuronal structure). Third, citicoline increases dopamine and norepinephrine levels in the brain. Both of these chemicals are involved in mood and well-being.

Studies have also demonstrated that caffeine is good for the long-term health of the brain. Many studies have revealed that the adenosine system (where caffeine works) helps to protect the brain after an injury. J Alzheimers Dis. 2009 July; 17(3):661-80. Many other studies have demonstrated the same protective properties of caffeine, including a study by Eskelinen et al demonstrating that midlife caffeine consumption significantly reduces the risk of dementia later in life. J Alzheimers Dis. 2009 January; 16(1):85-91.

Liquid dietary supplements that support memory and thinking skills are needed to improve cognitive performance.

### SUMMARY OF THE INVENTION

The present invention provides a liquid dietary supplement composition for supporting cognitive function. The composition includes lycopene and α-glyceryl phosphoryl choline or citicoline, and remains stable upon storage in a hermetically sealed, nitrogen purged aluminum can at room temperature for at least one year.

Also provided is an aqueous, heat-pasteurized liquid dietary supplement composition for supporting cognitive function including lycopene and α-glyceryl phosphoryl choline or citicoline.

In some instances, these compositions contain one or more of α-glyceryl phosphoryl choline, citicoline, α-tocopherol, a pH modifying agent, a sweetener, a flavorant, and caffeine. In some cases, the concentration of each of α-glyceryl phosphoryl choline, lycopene, α-tocopherol and citicoline is at most about 0.2 wt. % based on the total weight of the composition. The compositions of the invention are beverages in some cases, and can contain at least 95 wt. % water. In other instances, the compositions are in concentrated form.

In some embodiments, the composition is substantially free of ingredients that at the concentrations present in the composition are not generally recognized as safe or are artificial.

The compositions of the invention can be heat pasteurized at a temperature of from about 180 to about 190° F. for about 10 to about 40 seconds, preferably at a temperature of about 185° F. for at least about 20 seconds.

In some instances, the compositions of the invention include from about 100 mg to about 300 mg α-glyceryl phosphoryl choline, from about 2 mg to about 7 mg lycopene, from about 2 mg to about 7 mg α-tocopherol, from about 125 mg to about 500 mg citicoline, and up to about 200 mg caffeine in a single serving of the composition.

In some cases, the compositions include at least 95 percent by weight water, about 0.001 wt. % to about 0.003 wt. % lycopene and, if present, about 0.021 wt. % to about 0.063 wt. % alpha-glyceryl phosphoryl choline, about 0.002 wt. % to about 0.008 wt. % d-alpha tocopherol acetate, about 0.052 wt. % to about 0.208 wt. % citicoline, about 0.092 wt. % to about 0.440 wt. % pH modifying agent, about 1.255 wt. % to about 5.219 wt. % sweetener, about 0.083 wt. % to about 0.417 wt. % flavorant, and about 0.021 wt. % to about 0.084 wt. % caffeine.

In some instances, the compositions are concentrates including about 0.004 wt. % to about 0.012 wt. % lycopene and, if present, about 0.084 wt. % to about 0.252 wt. % alpha-glyceryl phosphoryl choline, about 0.008 wt. % to about 0.032 wt. % d-alpha tocopherol acetate, about 0.208 wt. % to about 0.832 wt. % citicoline, about 0.368 wt. % to about 1.760 wt. % pH modifying agent, about 5.020 wt. % to about 20.876 wt. % sweetener, about 0.332 wt. % to about 1.668 wt. % flavorant, and about 0.084 wt. % to about 0.336 wt. % caffeine.

In other instances, the concentrates include about 0.004 wt. % to about 0.045 wt. % lycopene and, if present, about 0.084 wt. % to about 0.945 wt. % alpha-glyceryl phosphoryl choline, about 0.008 wt. % to about 0.120 wt. % d-alpha tocopherol acetate, about 0.208 wt. % to about 3.120 wt. % citicoline, about 0.368 wt. % to about 6.600 wt. % pH modifying agent, about 5.020 wt. % to about 78.285 wt. % sweetener, about 0.332 wt. % to about 6.255 wt. % flavorant, and about 0.084 wt. % to about 1.260 wt. % caffeine.

In other embodiments, the concentrates include about 0.015 wt. % to about 0.045 wt. % lycopene and, if present, about 0.315 wt. % to about 0.945 wt. % alpha-glyceryl phosphoryl choline, about 0.030 wt. % to about 0.120 wt. % d-alpha tocopherol acetate, about 0.780 wt. % to about 3.120 wt. % citicoline, about 1.380 wt. % to about 6.600 wt. % pH modifying agent, about 18.825 wt. % to about 78.285 wt. % sweetener, about 1.245 wt. % to about 6.255 wt. % flavorant, and about 0.315 wt. % to about 1.260 wt. % caffeine.

A further aspect of the invention is a powdered composition including about 0.015 wt. % to about 0.045 wt. % lycopene and, if present, about 0.315 wt. % to about 0.945 wt. % alpha-glyceryl phosphoryl choline, about 0.030 wt. % to about 0.120 wt. % d-alpha tocopherol acetate, about 0.780 wt. % to about 3.120 wt. % citicoline, about 1.380 wt. % to about 6.600 wt. % pH modifying agent, about 18.825 wt. % to about 78.285 wt. % sweetener, about 1.245 wt. % to about 6.255 wt. % flavorant, and about 0.315 wt. % to about 1.260 wt. % caffeine.

### DETAILED DESCRIPTION

A liquid dietary supplement of this invention comprises a sufficient amount of each of the following ingredients: α-glyceryl phosphoryl choline, lycopene, Vitamin E (especially, for example, α-tocopherol) and citicoline. Each of these ingredients has been shown in peer-reviewed studies to support a key mechanism of brain aging upon ingestion of a particular minimum dosage. The liquid dietary supplement is provided to support memory and thinking skills. Specifically, the lycopene in the liquid dietary supplement provides anti-inflammatory protection. The vitamin E provides anti-oxidant protection. Alpha-glyceryl phosphoryl choline and citicoline help to increase acetylcholine levels in the brain. Citicoline also helps to provide phospholipids as structural support to brain cells. While it was desirable to formulate a liquid dietary supplement including these ingredients, the lycopene would precipitate out of solution upon storage, and an unpleasant after taste, bitterness, off-flavors, poorly balanced sweetness or chalkiness could result during formulation or upon storage. It was discovered that these problems could be overcome by heat pasteurization of the liquid dietary supplement and selection of ingredients to provide a liquid dietary supplement composition that is shelf stable.

It is also desirable that the liquid dietary supplement be aqueous and that the ingredients, therefore, be water-soluble at the levels at which they are incorporated into the liquid dietary supplement. It is preferred that the liquid dietary supplements of the present invention are in the form of a beverage or a concentrate that can be diluted to form a beverage. It is particularly desirable for the ingredients to remain water-soluble or water dispersible not only at room temperature, but at temperatures of refrigeration (such as 34-38° F.) and at elevated temperatures that the liquid dietary supplement could be exposed to during shipping and storage (such as 80-100° F.).

Moreover, considering that the liquid dietary supplement is designed for human consumption, it is also preferred that no ingredient of the liquid dietary supplement have an undesirable organoleptic characteristic. In particular, it is preferred that each of the ingredients, at the levels of their incorporation into the liquid dietary supplement, have no disagreeable taste, odor or feel to the tongue or mouth. It is especially desirable that the noted ingredients, α-glyceryl phosphoryl choline, lycopene, Vitamin E and citicoline, have no significant taste or odor so as to not interfere with other liquid dietary supplement ingredients that may be incorporated into the liquid dietary supplement for such properties.

Each of the ingredients α-glyceryl phosphoryl choline, lycopene, Vitamin E and citicoline will now be discussed in turn, including an identification of the contents of those ingredients preferred for inclusion in the liquid dietary supplement of this invention. References herein to a “sufficient amount” of these or other ingredients means at least the minimum amount identified for each such ingredient.

The α-glyceryl phosphoryl choline (sometimes referred to herein as “A-GPC”) content of the liquid dietary supplement composition is from about 50 mg to about 150 mg, which is about 0.021 to about 0.063 wt. % based on the total weight of the composition, preferably about 75 mg to about 150 mg, and more preferably about 100 mg (about 0.040 wt. % based on the total weight of the composition). A-GPC has been associated with an increase in acetylcholine in the body. A-GPC is commercially available; a preferred source is Alpha Size™ 50 WSP (Chemi Nutra, White Bear Lake, Minn.), which is (50% A-GPC and 50% mannitol). In order to provide about 50 mg to about 150 mg of A-GPC, the liquid dietary supplement composition can contain from about 100 mg to about 300 mg, which is about 0.042 to about 0.126 wt. % Alpha Size™ 50 WSP, preferably about 150 mg to about 300 mg, and more preferably about 200 mg Alpha Size™ 50 WSP based on the total weight of the liquid dietary supplement composition.

Preferably, the lycopene content is from about 2 mg to about 7 mg, such as about 3 mg to provide anti-inflammatory or anti-oxidant benefits. A daily intake of 5 to 7 mg of lycopene has been recommended, but it is reported that nearly half of Americans consume only 2 mg per day. Rao AV, Rao LG. Carotenoids and human health. Pharmacol Res. 2007; 55(3):207-16. Thus, the dose of lycopene provided by one embodiment of the present invention is intended to make up for the average difference between the recommended dose and typical dietary intake, although the entire recommended dose could be provided by the liquid dietary supplement.

Lycopene is commercially available from various sources, including Tomat-O-Red® 2% SG (LycoRed, Ltd., Israel), which is a suspension of micronized tomato lycopene crystals (2 wt. % lycopene) in glycerol, stabilized by sucrose esters and soy lecithin. In order to provide about 2 mg to about 7 mg of lycopene, preferably 3 mg lycopene, the liquid dietary supplement composition contains from about 100 mg to about 350 mg Tomat-O-Red® 2% SG, preferably about 135 mg Tomat-O-Red® 2% SG, which is about 0.041 to about 0.145 wt. %, preferably about 0.056 wt. % Tomat-O-Red® 2% SG based on the total weight of the liquid dietary supplement composition.

Vitamin E is a collective name for a set of 8 related α-, β-, γ-, and δ-tocopherols and the corresponding four tocotrienols. What is meant herein by the term “Vitamin E” is any one or more of such tocopherols or tocotrienols. Preferably, the Vitamin E ingredient is a Vitamin E from a natural source (“natural Vitamin E”) as opposed to synthetically-derived Vitamin E, and more preferably, the Vitamin E is α-tocopherol acetate, and even more preferably, the α-tocopherol acetate is d-α-tocopherol acetate. Most preferably, the d-α-tocopherol acetate is from a source in which it occurs naturally (“natural d-α-tocopherol acetate”) rather than synthetically derived. In the liquid dietary supplement of the present invention, natural Vitamin E (d-α-tocopherol), which is identified by the absence of the letter “I” after the “d” in d-α-tocopherol, is preferred.

Preferably, the Vitamin E content is from about 2 mg to about 20 mg, about 5 mg to about 20 mg, about 2 mg to about 15 mg, about 5 mg to about 15 mg, about 2 mg to about 10 mg, about 2 mg to about 7 mg, about 2 mg to about 5 mg, such as about 3 mg. In that the component of particular interest in Vitamin E is α-tocopherol acetate, it is preferred that the α-tocopherol acetate content be from about 2 mg to about 20 mg, about 5 mg to about 20 mg, about 2 mg to about 15 mg, about 5 mg to about 15 mg, about 2 mg to about 10 mg, about 2 mg to about 7 mg, about 2 mg to about 5 mg, such as about 3 mg. Where the α-tocopherol acetate is d-α-tocopherol acetate, it is preferred that the d-α-tocopherol acetate content be from about 2 mg to about 20 mg, about 5 mg to about 20 mg, about 2 mg to about 15 mg, about 5 mg to about 15 mg, about 2 mg to about 10 mg, about 2 mg to about 7 mg, about 2 mg to about 5 mg, such as about 3 mg.

Natural sources of Vitamin E are commercially available from various sources, such as Novatol™ E-700D (ADM, Decatur, Ill.) which consists of 47 wt. % d-alpha tocopherol acetate. In order to provide about 2 mg to about 20 mg, about 5 mg to about 20 mg, about 2 mg to about 15 mg, about 5 mg to about 15 mg, about 2 mg to about 10 mg, about 2 mg to about 7 mg, about 2 mg to about 5 mg, preferably 3 mg d-α-tocopherol acetate, the liquid dietary supplement composition contains from about 4 mg to about 42 mg, about 10 mg to about 42 mg, about 4 mg to about 32 mg, about 10 mg to about 32 mg, about 4 mg to about 21 mg, about 4 mg to about 15 mg, about 4 mg to about 10 mg, preferably 6 mg Novatol™ E-700D, which is about 0.002 to about 0.018 wt. %, about 0.004 to about 0.018 wt. %, about 0.002 to about 0.014 wt. %, about 0.004 to about 0.014 wt. %, about 0.002 to about 0.009 wt. %, about 0.002 to about 0.006 wt. %, about 0.002 to about 0.004 wt. %, preferably about 0.003 wt. % Novatol™ E-700D based on the total weight of the liquid dietary supplement composition.

Preferably, the citicoline content is from about 125 mg to about 500 mg, which is about 0.052 to about 0.208 wt. %, preferably from about 250 mg to about 500 mg, which is about 0.104 to about 0.208 wt. % based on the total weight of the composition. Citicoline may be obtained under the trademark Cognizin® from Kyowa Hakko Kogyo Co., Ltd. (New York, N.Y.), which contains 99-100% citicoline.

The liquid dietary supplement may be sweetened with cane sugar which exhibits a higher glycemic index than regular beet sugar. Other sweeteners, especially natural sweeteners, such as the 0 calorie natural sweetener Stevia or other stevia extracts, may be used or other low to no-calorie sweeteners. A preferred natural sweetener is Reb-A 97% (Pyure Brands, LLC, Naples, Fla.), which is a stevia extract containing 97% rebaudioside A. A sweetener or combination of sweeteners is present in the liquid dietary supplement composition in an amount ranging from about 3 g to about 12.5 g, preferably about 6 g to about 8 g, which is about 1.3 to about 5.2 wt. %, preferably about 2.5 to about 3.5 wt. %, based on the total weight of the liquid dietary supplement composition. In some instances, the liquid dietary supplement includes a combination of sweeteners, such as cane sugar and rebaudioside A, preferably in a weight ratio of cane sugar to rebaudioside A of about 333:1 to about 1,000:1, more preferably about 333:1 to about 500:1, and most preferably about 500:1.

Natural flavorants can also be added to the liquid dietary supplement to enhance its flavor. Preferably, a fruit flavorant is added, such as natural raspberry, orange, grape, or other fruit flavor.

The liquid dietary supplement can also include a pH modifying agent to decrease the pH of the liquid dietary supplement composition to a desirable range (pH of about 3 to about 4, preferably pH of about 3.3). The pH modifying agent can also preserve the Vitamin E in the formulation. Suitable pH modifying agents include citric acid, malic acid, and salts thereof, such as potassium citrate.

The liquid dietary supplement may be caffeinated or noncaffeinated, as desired. The noncaffeinated version preferably contains no stimulants, whereas the caffeinated version may contain as much caffeine as desired, such as about 50 mg to about 200 mg of caffeine (about 0.021 to about 0.084 wt. % based on the weight of the total composition), for example, 80 mg or 100 mg of caffeine. This dose of caffeine falls between a cup of strong tea and a cup of coffee and is believed to produce a pronounced effect in terms of memory and attention. Sources of caffeine are commercially available from various sources.

The liquid dietary supplement preferably is water-based. In a particularly preferred embodiment, the water is at least about 90 percent by weight, such as at least about 95 percent by weight water, and consists essentially of the ingredients noted herein. Preferably, the water is filtered. Also, preferably, the concentration of each of the ingredients α-glyceryl phosphoryl choline, lycopene, α-tocopherol and citicoline is at most about 0.2 percent by weight.

The liquid dietary supplement composition preferably contains the ingredients as specified in the following table:

| INGREDIENT | Range (mg) | Range (wt. %) | Preferred (mg) | Preferred (wt. %) |
|---|---|---|---|---|
| Water, | 223,800-238,700 | 93.732-99.533 | 231,562 | 96.676 |
| Filtered | | | | |
| Caffeine | 50-200 | 0.021-0.084 | 100 | 0.042 |
| Citicoline | 125-500 | 0.052-0.208 | 250-500 | 0.104-0.208 |
| Alpha Size ™ | 100-300 | 0.042-0.126 | 200 | 0.080 |
| 50 WSP | (50-150 A- | (0.021-0.063 | (100 A- | (0.040 A- |
| (A-GPC) | GPC) | A-GPC) | GPC) | GPC) |
| Novatol ™ E- | 10-42 (4.7-20 mg | 0.004-0.018 | 21(10 mg | 0.009 |
| 700D (d-alpha | d- | (0.002-0.008 | d-alpha | (0.004 d- |
| tocopherol | alpha | d-alpha | tocopherol | alpha |
| acetate) | tocopherol | tocopherol | acetate) | tocopherol |
| | acetate) | acetate)) | | acetate) |
| Cane Sugar | 3,000-12,500 | 1.25-5.21 | 6255 | 2.609 |
| Citric Acid | 100-500 | 0.042-0.210 | 236 | 0.099 |
| Tomat-O- | 100-350 (2-7 mg | 0.041-0.145 | 135 | 0.056 |
| Red ™ 2% SG | lycopene) | (0.001-0.003 | (3 mg | (0.001 |
| (Lycopene) | | lycopene) | lycopene) | lycopene) |
| Natural | 200-1,000 | 0.083-0.417 | 496 | 0.207 |
| Flavors | | | | |
| Malic Acid | 70-300 | 0.029-0.126 | 148 | 0.062 |
| Potassium | 50-250 | 0.021-0.104 | 118 | 0.049 |
| Citrate | | | | |
| Reb-A 97% | 15-20 | 0.005-0.009 | 18 | 0.007 |
| (i.e., | | | | |
| rebaudioside | | | | |
| A content) | | | | |
| TOTAL | | 100 | | 100 |

In another embodiment of the invention, the liquid dietary supplement is in a concentrate form to be diluted with water to prepare a ready to use composition for human consumption. In some instances, the concentrate comprises the ingredients listed above in the same relative proportions but with a water content reduced to less than 20, 15, 10 or 5 wt. % of the total concentrate composition. Such a concentrate is then diluted with water to form a ready to use dietary supplement containing the above listed ingredients in the amounts specified in the table above. In other instances, the concentrated liquid dietary supplement comprises at least 95 percent by weight water, about 0.001 wt. % to about 0.003 wt. % lycopene and, if present, about 0.021 wt. % to about 0.063 wt. % alpha-glyceryl phosphoryl choline, about 0.002 wt. % to about 0.008 wt. % d-alpha tocopherol acetate, about 0.052 wt. % to about 0.208 wt. % citicoline, about 0.092 wt. % to about 0.440 wt. % pH modifying agent, about 1.255 wt. % to about 5.219 wt. % sweetener, about 0.083 wt. % to about 0.417 wt. % flavorant, and about 0.021 wt. % to about 0.084 wt. % caffeine. In other instances, the compositions are concentrates including about 0.004 wt. % to about 0.012 wt. % lycopene and, if present, about 0.084 wt. % to about 0.252 wt. % alpha-glyceryl phosphoryl choline, about 0.008 wt. % to about 0.032 wt. % d-alpha tocopherol acetate, about 0.208 wt. % to about 0.832 wt. % citicoline, about 0.368 wt. % to about 1.760 wt. % pH modifying agent, about 5.020 wt. % to about 20.876 wt. % sweetener, about 0.332 wt. % to about 1.668 wt. % flavorant, and about 0.084 wt. % to about 0.336 wt. % caffeine. In yet other instances, the concentrates include about 0.004 wt. % to about 0.045 wt. % lycopene and, if present, about 0.084 wt. % to about 0.945 wt. % alpha-glyceryl phosphoryl choline, about 0.008 wt. % to about 0.120 wt. % d-alpha tocopherol acetate, about 0.208 wt. % to about 3.120 wt. % citicoline, about 0.368 wt. % to about 6.600 wt. % pH modifying agent, about 5.020 wt. % to about 78.285 wt. % sweetener, about 0.332 wt. % to about 6.255 wt. % flavorant, and about 0.084 wt. % to about 1.260 wt. % caffeine. In other embodiments, the concentrates include about 0.015 wt. % to about 0.045 wt. % lycopene and, if present, about 0.315 wt. % to about 0.945 wt. % alpha-glyceryl phosphoryl choline, about 0.030 wt. % to about 0.120 wt. % d-alpha tocopherol acetate, about 0.780 wt. % to about 3.120 wt. % citicoline, about 1.380 wt. % to about 6.600 wt. % pH modifying agent, about 18.825 wt. % to about 78.285 wt. % sweetener, about 1.245 wt. % to about 6.255 wt. % flavorant, and about 0.315 wt. % to about 1.260 wt. % caffeine.

In another embodiment, the dietary supplement can be made in powdered form containing less than 2 or 1 wt. % water and comprising from about 0.015 wt. % to about 0.045 wt. % lycopene and, if present, about 0.315 wt. % to about 0.945 wt. % alpha-glyceryl phosphoryl choline, about 0.030 wt. % to about 0.120 wt. % d-alpha tocopherol acetate, about 0.780 wt. % to about 3.120 wt. % citicoline, about 1.380 wt. % to about 6.600 wt. % pH modifying agent, about 18.825 wt. % to about 78.285 wt. % sweetener, about 1.245 wt. % to about 6.255 wt. % flavorant, and about 0.315 wt. % to about 1.260 wt. % caffeine.

Thus, the overall formula of the present invention is believed to support memory and thinking skills in multiple ways. Without being bound to any particular theory, it is believed that the lycopene provides anti-inflammatory protection, the natural Vitamin E provides powerful anti-oxidant protection, and the α-glyceryl phosphoryl choline and citicoline increase acetylcholine levels in the brain, therefore to aid memory and thinking skills. Finally, citicoline is believed to provide phospholipid support to brain cells and to increase the release of two key chemicals (dopamine and norepinephine). The scientific theory for including these ingredients is based on numerous scientific studies showing that levels of these are below recommended levels for adults and low levels relate to poor memory and thinking skills. O'Hara R, Derouesne C, Fountoulakis K, Yesavage J. Therapeutic approaches to age-associated neurocognitive disorders, 2001, Dialogues in Clinical Neuroscience, 3, 191-213.

The liquid dietary supplement may be carbonated or noncarbonated, but a preferred embodiment is a noncarbonated, water-based drink with mild sweetness.

The liquid dietary supplement may be formulated to be free of sodium or with very low sodium content, such as about 10 mg or less, and with a low calorie content, preferably less than about 100 calories, more preferably less than about 50 calories, such as about 5, 10, 15, 20, 25 or 30 calories, based on a serving size, for example, of about 8 fluid ounces.

It is desirable that each of the ingredients noted above, α-glyceryl phosphoryl choline, lycopene, Vitamin E and citicoline—and, indeed, all of the ingredients of the liquid dietary supplement—be obtained from a natural source of the ingredient rather than be synthesized. Moreover, it is preferred that the ingredients all be non-toxic and generally recognized as safe (GRAS approved), at least at the levels incorporated into a liquid dietary supplement of this invention. It is also preferred that all of the active ingredients of the liquid dietary supplement are components of the human body or essential components produced by the human body in maintaining bodily function.

Preferably, the liquid dietary supplement contains no or an insignificant amount (i.e., a non-therapeutic amount in a human) of B vitamins, taurine, yerba mate, guarna extract, Ginkgo, soy-based phosphatidylserine, or choline bitrate, as well as no or minimal artificial preservatives, artificial colors or artificial flavors. More preferably, the liquid dietary supplement is free of at least one of the following: B vitamins, taurine, yerba mate, guarna extract, ginseng, Ginkgo, soy-based phosphatidylserine, choline bitrate, artificial preservatives, artificial colors or artificial flavors. Most preferably, the liquid dietary supplement is free of B vitamins, taurine, yerba mate, guarna extract, ginseng, Ginkgo, soy-based phosphatidylserine, choline bitrate, artificial preservatives, artificial colors and artificial flavors.

The liquid dietary supplement may be prepared simply by mixing together the ingredients. No order to the addition is believed critical, although in a preferred embodiment, each of the ingredients is added to the water. The liquid dietary supplement may be made in single serving amounts or in bulk. In some embodiments, the ingredients other than water may be aggregated together as a water additive.

Once the liquid dietary supplement ingredients are mixed together, the liquid dietary supplement is heat pasteurized at a temperature of about 180 to about 190° F., preferably at about 185° F. for about 10 to about 40 seconds, preferably about 20 seconds. The liquid dietary supplement can then be filled into containers and cooled. In some embodiments, the liquid dietary supplement is hot-fill processed into aluminum cans that may be lined with a coating to prevent any metallic flavor. It has been discovered that this heat pasteurization process minimizes or prevents precipitation of lycopene from the liquid dietary supplement composition during storage for at least one year at room temperature, or preferably for at least one year under accelerated storage at 89.6° F.

As discussed herein, the liquid dietary supplement is based on an assumption of a serving size of 8 fluid ounces. Of course, other serving sizes are possible and the concentration of the ingredients may be adjusted accordingly. Thus, for example, where a concentration of a particular ingredient is identified as 1 percent, that concentration is based on a serving size of 8 fluid ounces and if a serving size of 6 fluid or 12 fluid ounces is selected instead of 8 fluid ounces, the concentration of the ingredient may be adjusted to 1.33 percent or 0.67 percent, respectively, to produce the same amount or dosage of the ingredient as in the 8 fluid ounce serving size.

By contrast, the absolute dosage or content of an ingredient would be the same regardless of the suggested serving size. Thus, if, for example, a content of a particular ingredient is identified as 100 mg, the content of the ingredient is 100 mg regardless of the suggested serving size. For example, the content is 100 mg whether the suggested serving size is 8 fluid ounces, 6 fluid ounces or 12 fluid ounces, even though the concentration of the ingredient is 16.7 mg/fl. oz. for the 6 fluid ounce serving size, 12.5 mg/fl. oz. for the 8 fluid ounce serving size and 8.3 mg/fl. oz. for the 12 fluid ounce serving size. Although any serving size is within the contemplation of this invention, generally, a serving size of about 8 fluid ounces is anticipated to be the most desirable commercial version of the invention, and serving sizes of about 4 fluid ounces to about 20 fluid ounces are expected to be common options as well. High concentration, low serving size alternatives (1 ounce or 2 ounces), particularly in high viscosity embodiments (such as gels), are possible as well.

Because the liquid dietary supplement targets mental aspects that may decline with age, it may be formulated and marketed for the middle age or older adult market. Moreover, the liquid dietary supplement may be marketed with a memory test, which may be an online test, for consumers to track their cognitive health. A person preferably consumes one or two servings of the liquid dietary supplement per day to increase cognitive function, such as thinking skills and mental acuity.

### EXAMPLES

Various liquid dietary supplement compositions were prepared according to the following formulae. Ingredients listed by weight are per 8 ounce serving with filtered water added as the remaining ingredient until the composition was 8 fluid ounces in volume unless otherwise specified.

Formula A:

| | | |
|---|---|---|
| Ginkgo biloba | 60 mg | |
| Lycopene (Tomat-O-Red ™ 2% SG) | 5 mg | |
| Vitamin C | 12 mg | (20% RDA) |
| Vitamin E (Novatol ™ E-700D) | 3 IU; 2 mg | (25% RDA) |
| Vitamin B12 | 0.4 mcg | (20% RDA) |
| Vitamin D2 | 80 IU | (20% RDA) |
| Calcium | 240 mg | (20% RDA) |

This liquid dietary supplement formulation was prepared by mixing the ingredients into filtered water and pouring the liquid dietary supplement into sealed plastic (polyethylene terephthalate (PET)) containers. After one week of storage, the liquid dietary supplement was dark red in color, cloudy, chalky, flavorless and resulted in formation of a precipitate as well as floating particles within the liquid dietary supplement.

Formulae B, C and D were prepared and stored in the same manner as Formula A.

Formula B1:

| | | |
|---|---|---|
| Lycopene (Tomat-O-Red ™ 2% SG) | 2.5 mg | |
| Vitamin E (Novatol ™ E-700D) | 1.5 IU; 1 mg | (12% RDA) |
| Vitamin B12 | 0.4 mcg | (20% RDA) |
| Juice concentrate | | |
| Vanilla | | |
| Masking agent | | |
| Berry flavor | | |

Formula B2:

| | | |
|---|---|---|
| Ginkgo biloba | 40 mg | |
| Lycopene (Tomat-O-Red ™ 2% SG) | 2.5 mg | |
| Vitamin E (Novatol ™ E-700D) | 1.5 IU; 1 mg | (12% RDA) |
| Vitamin B12 | 0.4 mcg | (20% RDA) |
| Juice concentrate | | |
| Vanilla | | |
| Berry flavor | | |

Formula Cl:

| | | |
|---|---|---|
| Ginkgo biloba | 40 mg | |
| Lycopene (Tomat-O-Red ™ 2% SG) | 2.5 mg | |
| Vitamin C | 12 mg | (20% RDA) |
| Vitamin E (Novatol ™ E-700D) | 1.5 IU; 1 mg | (12% RDA) |
| Vitamin B12 | 0.4 mcg | (20% RDA) |
| Vitamin D2 | 80 IU | (20% RDA) |
| Calcium | 240 mg | (20% RDA) |

Although Formulae B and C were less chalky and had a lighter color than Formula A, the Formulae were still cloudy, and lycopene precipitated upon storage of the liquid dietary supplement for one week. Formulae B had poor flavor, and Formulae B2 and C1 had floating particles upon storage.

Formula C2 (comparative):

| | | |
|---|---|---|
| Ginkgo biloba | 40 mg | |
| Vitamin C | 12 mg | (20% RDA) |
| Vitamin E (Novatol ™ E-700D) | 1.5 IU; 1 mg | (12% RDA) |
| Vitamin B12 | 0.4 mcg | (20% RDA) |
| Vitamin D2 | 80 IU | (20% RDA) |
| Calcium | 240 mg | (20% RDA) |

Formula C2 was prepared to compare the effect of removing lycopene. The liquid dietary supplement was less chalky, more clear and much lighter in color, but still included floating particles upon storage.

Formula C3:

| | | |
|---|---|---|
| Lycopene (Tomat-O-Red ™ 2% SG) | 2.5mg | |
| Vitamin C | 12 mg | (20% RDA) |
| Vitamin E (Novatol ™ E-700D) | 1.5 IU; 1 mg | (12% RDA) |
| Vitamin B12 | 0.4 mcg | (20% RDA) |
| Vitamin D2 | 80 IU | (20% RDA) |
| Calcium | 240 mg | (20% RDA) |
| Maltodextrin | | |

Formula C3 was prepared to remove ginkgo and add maltodextrin as compared to Formula C1. The liquid dietary supplement was less chalky, somewhat clear and lighter in color.

Formula D (comparative):

| | | |
|---|---|---|
| Vitamin C | 12 mg | (20% RDA) |
| Vitamin E (Novatol ™ E-700D) | 1.5 IU; 1 mg | (12% RDA) |
| Vitamin B12 | 0.4 mcg | (20% RDA) |
| Vitamin D2 | 80 IU | (20% RDA) |
| Calcium | 240 mg | (20% RDA) |
| Acesulfame potassium | | |

Formula D was prepared to remove ginkgo and lycopene and add sweetener as compared to Formula C1. The liquid dietary supplement was clear but too sweet.

Formulae E, F, G and H were prepared and stored in the same manner as Formula A, except that the liquid dietary supplement formulations were heat pasteurized at 185° F. for 20 seconds prior to bottling. Unlike Formulae A-D, Formulae E1 had excellent flavor and lycopene did not precipitate out of solution from either of Formulae E after storage for 12 weeks. As compared to Formula E1, Formula E2 was too sweet and had a lingering aftertaste.

| Formula E1: | (grams/8 ounce serving): |
|---|---|
| Vitamin Blend* | 0.024 |
| Turbinado Sugar | 2.300 |
| Tomat-O-Red ™ 2% SG | 0.050 |
| Citric Acid | 0.025 |
| Natural Mixed Berry flavor | 0.230 |

*9.09% Novatol ™ E-700D (containing vitamin E) and 90.91% Alpha Size ™ 50 WSP (containing A-
GPC)

| Formula E2: | (grams/8 ounce serving): |
|---|---|
| Vitamin Blend* | 0.024 |
| Turbinado Sugar | 2.300 |
| Tomat-O-Red ™ 2% SG | 0.050 |
| Citric Acid | 0.025 |
| Natural Mixed Berry flavor | 0.230 |
| Oh So Sweet ™ natural sweetener | |
| Caffeine malate | |

*9.09% Novatol ™ E-700D (containing vitamin E) and 90.91% Alpha Size ™ 50 WSP (containing A-
GPC)

| Formula F: | Wt. % |
|---|---|
| Citicoline | 0.104 |
| Alpha Size ™ 50 WSP | 0.080 |
| Novatol ™ E-700D | 0.009 |
| Cane Sugar | 2.609 |
| Citric Acid | 0.099 |
| Malic Acid | 0.062 |
| Potassium Citrate | 0.049 |
| Reb-A 97% | 0.007 |
| Tomat-O-Red ™ 2% SG | 0.056 |
| Natural Raspberry Flavor | 0.200 |
| WONF #31491 | |
| Luo Han Guo sweetener | 0.007 |
| Filtered water | QS to 100.000 |

Formula F had a bitter aftertaste as compared to Formula E1.

| Formula G1: | Wt. % |
|---|---|
| Citicoline | 0.104 |
| Alpha Size ™ 50 WSP | 0.080 |
| Novatol ™ E-700D | 0.009 |
| Cane Sugar | 2.609 |
| Citric Acid | 0.099 |
| Malic Acid | 0.062 |
| Potassium Citrate | 0.049 |
| Reb-A 97% | 0.007 |
| Tomat-O-Red ™ 2% SG | 0.056 |
| Natural Raspberry Flavor | 0.200 |
| WONF #31491 | |
| Filtered water | QS to 100.000 |

| Formula G2: | Wt. % |
|---|---|
| Citicoline | 0.104 |
| Alpha Size ™ 50 WSP | 0.080 |
| Novatol ™ E-700D | 0.009 |
| Cane Sugar | 2.609 |
| Citric Acid | 0.099 |
| Malic Acid | 0.062 |
| Potassium Citrate | 0.049 |
| Reb-A 97% | 0.007 |
| Tomat-O-Red ™ 2% SG | 0.056 |
| Natural Raspberry Flavor | 0.200 |
| WONF #31491 | |
| Caffeine Natural 95% | 0.042 |
| Filtered water | QS to 100.000 |

Natural colorants (e.g., grape skin extract, carrot juice, cochineal extract mixture) were added to formulae G but were later eliminated from these formulations as undesirable.

| Formula H1: | Wt. % |
|---|---|
| Citicoline | 0.208 |
| Alpha Size ™ 50 WSP | 0.080 |
| Novatol ™ E-700D | 0.009 |
| Cane Sugar | 2.609 |
| Citric Acid | 0.099 |
| Malic Acid | 0.062 |
| Potassium Citrate | 0.049 |
| Reb-A 97% | 0.007 |
| Tomat-O-Red ™ 2% SG | 0.056 |
| Natural Raspberry Flavor | 0.200 |
| WONF #31491 | |
| Filtered water | QS to 100.000 |

| Formula H2: | Wt. % |
|---|---|
| Citicoline | 0.208 |
| Alpha Size ™ 50 WSP | 0.080 |
| Novatol ™ E-700D | 0.009 |
| Cane Sugar | 2.609 |
| Citric Acid | 0.099 |
| Malic Acid | 0.062 |
| Potassium Citrate | 0.049 |
| Reb-A 97% | 0.007 |
| Tomat-O-Red ™ 2% SG | 0.056 |
| Natural Raspberry Flavor | 0.200 |
| WONF #31491 | |
| Caffeine Natural 95% | 0.042 |
| Filtered water | QS to 100.000 |

The formulae containing natural raspberry had improved flavor as compared to the other flavored formulations.

The following formulation was prepared and stored as described above:

| | | | | | grams |
|---|---|---|---|---|---|
| | | | Total | | per |
| | 1000 gallon | | Weight | | 8 oz |
| INGREDIENT | Volume | | (lbs) | % By Weight | serving |
| Water, Filtered | 979.86 | gal | 8177 | 96.677% | 231.812 |
| Caffeine | 3.527 | lb | 3.527 | 0.042% | 0.100 |
| Citicoline | 8.81 | lb. | 8.81 | 0.104% | 0.250 |
| Alpha Size | 3.066 | kilos | 6.75 | 0.080% | 0.191 |
| Novatol | 0.333 | kilos | 0.734 | 0.009% | 0.021 |
| Cane Sugar | 220.65 | lb | 220.65 | 2.609% | 6.255 |
| Citric Acid | 8.34 | lb | 8.34 | 0.099% | 0.236 |
| Tomato Red 2% | 2.157 | kilos | 4.75 | 0.056% | 0.135 |
| Natural Flavors | 2.20 | gallons | 17.5 | 0.207% | 0.496 |
| Malic Acid | 5.21 | lb. | 5.21 | 0.062% | 0.148 |
| Potassium | 4.17 | lb. | 4.17 | 0.049% | 0.118 |
| Citrate | | | | | |
| Reb-A 99% | 0.625 | lb. | 0.625 | 0.007% | 0.018 |

| | | |
|---|---|---|
| TOTAL: | 8458.066 | 100.000% |

When introducing elements of the present invention or the embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions and methods without departing from the scope of the invention, it is intended that all matter contained in the above description shall be interpreted as illustrative and not in a limiting sense.

What is claimed is:

1. A liquid dietary supplement composition for supporting cognitive function comprising lycopene and α-glyceryl phosphoryl choline or citicoline, wherein the liquid dietary supplement composition remains stable upon storage in a hermetically sealed, nitrogen purged aluminum can at room temperature for at least one year.

2. An aqueous, heat-pasteurized liquid dietary supplement composition for supporting cognitive function comprising lycopene and α-glyceryl phosphoryl choline or citicoline.

3. The composition of claim 1 further comprising α-glyceryl phosphoryl choline.

4. The composition of claim 1 further comprising citicoline.

5. The composition of claim 1 further comprising α-tocopherol.

6. The composition of claim 1 further comprising a pH modifying agent.

7. The composition of claim 1 further comprising a sweetener.

8. The composition of claim 1 further comprising a flavorant.

9. The composition of claim 1 further comprising caffeine.

10. The composition of claim 1 wherein the composition comprises α-glyceryl phosphoryl choline, lycopene, α-tocopherol and citicoline and the concentration of each of α-glyceryl phosphoryl choline, lycopene, α-tocopherol and citicoline is at most about 0.2 wt. % based on the total weight of the composition.

11. The composition of claim 1 comprising at least 95 percent by weight water, about 0.001 wt. % to about 0.003 wt. % lycopene and, if present, about 0.021 wt. % to about 0.063 wt. % alpha-glyceryl phosphoryl choline, about 0.002 wt. % to about 0.008 wt. % d-alpha tocopherol acetate, about 0.052 wt. % to about 0.208 wt. % citicoline, about 0.092 wt. % to about 0.440 wt. % pH modifying agent, about 1.255 wt. % to about 5.219 wt. % sweetener, about 0.083 wt. % to about 0.417 wt. % flavorant, and about 0.021 wt. % to about 0.084 wt. % caffeine.

12. The composition of claim 1 comprising about 0.004 wt. % to about 0.012 wt. % lycopene and, if present, about 0.084 wt. % to about 0.252 wt. % alpha-glyceryl phosphoryl choline, about 0.008 wt. % to about 0.032 wt. % d-alpha tocopherol acetate, about 0.208 wt. % to about 0.832 wt. % citicoline, about 0.368 wt. % to about 1.760 wt. % pH modifying agent, about 5.020 wt. % to about 20.876 wt. % sweetener, about 0.332 wt. % to about 1.668 wt. % flavorant, and about 0.084 wt. % to about 0.336 wt. % caffeine.

13. The composition of claim 1 comprising about 0.004 wt. % to about 0.045 wt. % lycopene and, if present, about 0.084 wt. % to about 0.945 wt. % alpha-glyceryl phosphoryl choline, about 0.008 wt. % to about 0.120 wt. % d-alpha tocopherol acetate, about 0.208 wt. % to about 3.120 wt. % citicoline, about 0.368 wt. % to about 6.600 wt. % pH modifying agent, about 5.020 wt. % to about 78.285 wt. % sweetener, about 0.332 wt. % to about 6.255 wt. % flavorant, and about 0.084 wt. % to about 1.260 wt. % caffeine.

14. The composition of claim 1 comprising about 0.015 wt. % to about 0.045 wt. % lycopene and, if present, about 0.315 wt. % to about 0.945 wt. % alpha-glyceryl phosphoryl choline, about 0.030 wt. % to about 0.120 wt. % d-alpha tocopherol acetate, about 0.780 wt. % to about 3.120 wt. % citicoline, about 1.380 wt. % to about 6.600 wt. % pH modifying agent, about 18.825 wt. % to about 78.285 wt. % sweetener, about 1.245 wt. % to about 6.255 wt. % flavorant, and about 0.315 wt. % to about 1.260 wt. % caffeine.

15. The composition of claim 1 wherein the composition is substantially free of ingredients that at the concentrations present in the composition are not generally recognized as safe or are artificial.

16. The composition of claim 1 wherein the composition is heat pasteurized at a temperature of from about 180 to about 190° F. for about 10 to about 40 seconds.

17. The composition of claim 1 wherein the composition is heat pasteurized at a temperature of about 185° F. for at least about 20 seconds.

18. The composition of claim 1 comprising from about 100 mg to about 300 mg α-glyceryl phosphoryl choline, from about 2 mg to about 7 mg lycopene, from about 2 mg to about 7 mg α-tocopherol, from about 125 mg to about 500 mg citicoline, and up to about 200 mg caffeine in a single serving of the composition.

19. A liquid dietary supplement composition comprising a sufficient amount of each of the following ingredients: α-glyceryl phosphoryl choline, lycopene, α-tocopherol and citicoline.

20. The composition of claim 19 wherein the liquid dietary supplement is aqueous.

21. The composition of claim 20 comprising over 95 percent by weight water.

22. The composition of claim 21 wherein the concentration of each of the ingredients α-glyceryl phosphoryl choline, lycopene, α-tocopherol and citicoline is at most about 0.2 percent by weight.

23. A liquid dietary supplement composition comprising from about 100 mg to about 300 mg α-glyceryl phosphoryl choline, from about 2 mg to about 7 mg lycopene, from about 2 mg to about 7 mg α-tocopherol and from about 125 mg to about 250 mg citicoline.

24. The composition of claim 23 wherein the liquid dietary supplement is aqueous.

25. The composition of claim 24 comprising over 95 percent by weight water.

26. The composition of claim 19 further comprising a sufficient amount of caffeine.

27. The composition of claim 23 wherein all ingredients of the liquid dietary supplement are generally recognized as safe.

28. The composition of claim 19 wherein the composition is a beverage.

29. A powdered dietary supplement composition for dilution with water to form a liquid dietary supplement, the powdered dietary supplement comprising about 0.015 wt. % to about 0.045 wt. % lycopene and, if present, about 0.315 wt. % to about 0.945 wt. % alpha-glyceryl phosphoryl choline, about 0.030 wt. % to about 0.120 wt. % d-alpha tocopherol acetate, about 0.780 wt. % to about 3.120 wt. % citicoline, about 1.380 wt. % to about 6.600 wt. % pH modifying agent, about 18.825 wt. % to about 78.285 wt. % sweetener, about 1.245 wt. % to about 6.255 wt. % flavorant, and about 0.315 wt. % to about 1.260 wt. % caffeine.
